(19) United States
(12) Patent Application Publication
(10) Pub. No.: US 2021/0292191 A1
(43) Pub. Date: Sep. 23, 2021

(54) Filtration media, system and method for the removal of phosphorus and coliforms

(71) Applicant: 11814192 Canada Inc., Sherbrooke, Quebec (CA)

(72) Inventors: Benoit Boucher, Sherbrooke, Quebec (CA); Cheikh Mor Mbacke, Sherbrooke, Quebec (CA)

(21) Appl. No.: 17/273,473

(22) PCT Filed: Sep. 6, 2019
(86) PCT No.: PCT/CA2019/051254

§ 371 Date: Mar. 4, 2021

Related U.S. Application Data
(60) Provisional application No. 62/727,901, filed on Sep. 6, 2018.

(51) Int. Cl. C02F 1/28; B01D 39/06; B01D 24/12; B01D 24/40

(52) U.S. Cl. CPC C02F 1/281; B01D 39/06; C02F 2101/105; B01D 24/40; B01D 24/12

(57) ABSTRACT

A filtration media, system and method to passively remove phosphorus and coliforms from wastewater streams is provided. The filtration media system allows wastewater to enter via an inlet toward a diffusor, a filtration media and a filtration media support. The filtered wastewater exits through an outlet. In one aspect, the filtration media broadly comprises sand, activated alumina, peat moss or lime, or any combination thereof. In an exemplary embodiment, the dephosphatation media may further comprise about 20-65% filtration grade sand, about 7-14% granular activated alumina, about 25-50% peat moss and about 5-20% dolomitic lime. The filtration media system may be used in a wastewater treatment method to passively remove phosphorus and coliforms from sewage streams. The dephosphatation media system may be used to passively treat domestic, industrial and commercial sewage streams.

### CROSS-REFERENCE TO RELATED APPLICATIONS

The present application claims the benefit of U.S. Provisional Patent Application No. 62/727,901 filed on Sep. 6, 2018, the contents of which are hereby incorporated by reference.

### FIELD OF THE INVENTION

The present invention generally relates to the field of wastewater and sewage filtration system and treatment methods. More particularly, the present invention relates to filtration systems and treatment methods for the passive removal of phosphorus and coliforms.

### BACKGROUND OF THE INVENTION

Microbial pollution is caused by the presence in water of pathogenic micro-organisms from human and animal excreta. For public health reasons, it is often necessary to disinfect wastewater before it is discharged into surface water. Popular disinfection techniques that do not cause adverse effects on aquatic life and do not generate undesirable by-products for public health include ozonation, ultraviolet radiation, lagooning, various filtration systems and chlorination systems.

Filtration methods provide a more cost-effective approach for removing contaminants from wastewater streams, especially from sewage. Over the years, many methods have been proposed to remove phosphorus and coliforms. The removal of phosphorus and coliforms can be achieved through biological, chemical or physical means. In a biological method, the removal is carried out through the use of bacteria or plants, while in a chemical method, the removal is achieved by chemical agents that result in the production of a sludge. Since most treatment methods to precipitate phosphates are of a chemical nature and costly, there has been a drive over the last few years to develop efficient and lower-cost alternatives.

Lower cost treatments usually involve the passive removal of phosphorus and coliforms through physical means, such as filters. The passive removal of contaminants represents a more efficient and less energy intensive method to treat wastewater. As an example, U.S. Pat. No. 9,682,879 (Dube et al.) teaches the use of activated wood chips and peat moss to remove phosphorus from wastewater streams. US Patent Publication No. US 2010/0243571 (Semiat et al.) describes the passive removal of phosphorus using particles of transition metal oxides or hydroxides, TiO₂, or mixtures thereof, as well as particles of activated carbon, activated alumina, aluminium oxide, activated TiO₂, mineral clay, zeolite and even an ion exchanger using nanoparticles of these materials. Another example in which the use of oxides to remove contaminants is disclosed is US Patent Publication No. US 2011/0303609 (Isovitsch Parks et al.).

Alternative methods for the removal of phosphorus include the use of zeolite in circulation adsorption columns, as described in KR 1016822907 (Seok et al.), and the use of support media containing metals, as taught by CA 2,305,014A1 (Cronitech). In yet another example of an alternative method to remove phosphorus, peat moss was used as a green filtration medium, as disclosed in U.S. Pat. No. 7,927,484 (Wanielista et al.).

Despite the above developments in the field of phosphorus and coliform removal from wastewater, there remains a need for efficient and complete wastewater treatment media, systems and methods based on the passive removal of phosphorus and coliforms with reduced energy and maintenance costs. The present invention seeks to address this need by providing novel media, systems and methods to treat wastewater originating from domestic, commercial and industrial sewage streams and septic tanks.

### SUMMARY OF THE INVENTION

A solution to the shortcomings of the prior art is proposed by a novel passive wastewater treatment method and system for the removal of phosphorus and coliforms.

The present invention comprises novel filtration media, systems and methods to treat wastewater streams originating from domestic, commercial and industrial sewage streams by removing phosphorus and coliforms. The invention may also be used to remove phosphorus and coliforms from sewage streams originating from septic tanks.

The filtration media may comprise sand, activated alumina, peat moss or lime, or any combination thereof. The filtration media may further comprise one or more other filtration material(s) suitable to remove phosphorus and coliforms from wastewater or sewage streams.

In one aspect of the invention, the filtration media is used in a filtration media system to passively remove phosphorus and coliforms from wastewater or sewage streams. The filtration media system comprises a housing or container; an inlet; a filtration media; a filtration media support; and an outlet. The filtration media system may optionally include a diffusing mechanism near or at the end of the inlet.

In yet another aspect of the invention, the filtration media is used in a method to passively remove phosphorus and coliforms from wastewater or sewage streams. The method comprises pumping and directing wastewater or sewage streams in the filtration media system; allowing the wastewater to infiltrate the filtration media and accumulate at the bottom of the filtration media system; and allowing the filtered water accumulated at the bottom of the filtration media system to exit via the outlet.

The filtration media of the present invention may also be used in a dephosphatation step of a wastewater treatment method to passively remove phosphorus and coliforms. In one particular embodiment of the present invention, the novel filtration media may be used as a treatment step in a wastewater treatment method as described in International Patent Application No. PCT/CA2019/051229, which is hereby incorporated by reference.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is an illustration of an embodiment of a dephosphatation system and media;

FIG. 2 is a plot of an exemplary method of dephosphatation showing the phosphorus concentration as a function of the weeks in both inlet and outlet streams;

FIG. 3 is a plot of the fecal coliforms content in an exemplary method of dephosphatation, the plots presenting the fecal coliforms concentration as a function of the number of weeks of the exemplary method at both inlet and outlet streams; and

FIG. 4 is an illustration of an embodiment of a dephosphatation system and media shown with exemplary dimensions.

### DETAILED DESCRIPTION OF THE PREFERRED EMBODIMENT

A novel dephosphatation media for phosphorus removal will be described hereinafter. Although the invention is described in terms of specific illustrative embodiments, it is to be understood that the embodiments described herein are by way of example only and that the scope of the invention is not intended to be limited thereby.

For purposes of the present application, “dephosphatation system” refers to a system that allows phosphorus and coliforms present in the effluent of a wastewater treatment system to be captured for removal purposes. The expressions “dephosphatation media”, “filtration media” and “filtering media” are used interchangeably and generally refer to media used to capture and remove phosphorus and coliforms, in accordance with the present invention.

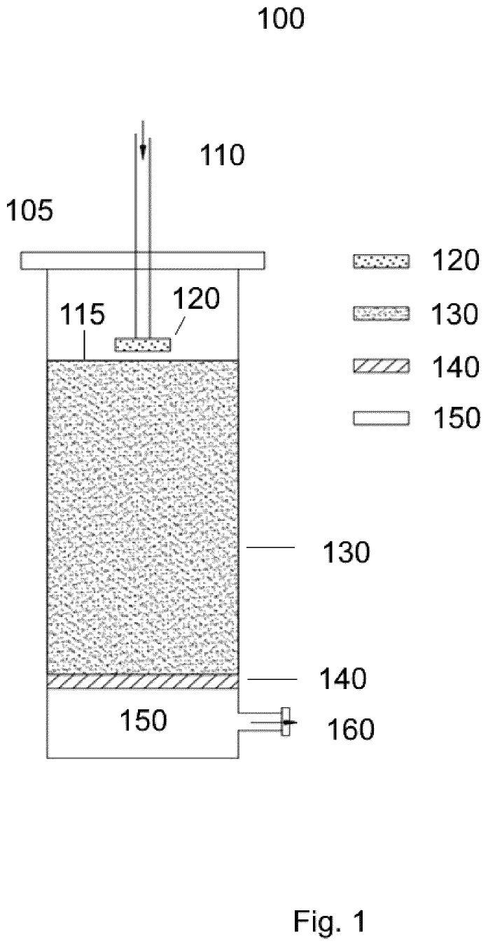

Now referring to FIG. 1, an embodiment of a dephosphatation system 100 is shown. The system 100 comprises a housing 105 or container, an inlet 110, such as an entry conduit, a filtration media 130, a filtration media support 140 and an outlet 160. The system 100 may further comprise a diffusing mechanism 120 near or at the end of the inlet 110.

In a typical embodiment, the wastewater or contaminated liquid may be pumped or otherwise directed to the top of the filtration media via the entry conduit 110. The diffuser 120 is located in the top portion of the housing 105 and is generally adapted to distribute the wastewater evenly on the top surface 115 of the filtration media 130.

The wastewater then flows in a generally downward direction through the filtration media 130. The filtered water eventually accumulates in the bottom portion 150 of the filtration system 100 after passing through the filtration media support 140. The filtered water that has accumulated at the bottom of the filtration system will exit the system via the outlet conduit 160 when the volume of filtered water in the bottom portion 150 of the filtration system 100 reaches the outlet conduit 160. The filtered water may then be distributed through conduits or pipes or contained and removed.

The filtration media 130 may comprise filtration media materials selected from the group consisting of sand, activated alumina, peat moss, lime, and any combination thereof. The filtration media may further comprise one or more other media material(s) suitable for removing phosphorus and coliforms originating from wastewater or sewage streams.

In one exemplary embodiment, the filtration media 130 may comprise:
about 20-65 vol % of a sand filtering media;
about 7-14 vol % of granular activated alumina;
about 25-50 vol %, of peat moss; and
about 5-20 vol % of dolomitic lime comprising a mixture of calcium carbonate and magnesium carbonate.

In another exemplary embodiment, the sand filtering media has the following characteristics:
an effective diameter (D10) between about 0.15 and about 1 mm;
a uniformity coefficient (Cu) being less than or equal to about 6;
about 3% or less of the particles having a diameter less than about 80 μm; and
about 20% or less of the particles having a diameter greater than about 2.5 mm.

In yet another embodiment, the dolomitic lime mixture may further have a density of about 17.7±1.8 lb/m³ with an uncertainty of about 10%.

The granular activated alumina is generally known in the art to remove fluoride present in wastewater streams. In the present invention, granular activated alumina may be used to remove phosphorus and coliforms from wastewater streams as demonstrated in the present invention. Although the activated alumina is commercially available in different sizes, tests demonstrated that the mesh 14×28, equivalent to a particle size of between about 0.6 and about 1.5 mm, is advantageous for the application of the present invention.

The following examples are shown as a result of several tests and typical physical and chemical analysis.

### Example 1—Activated Alumina Typical Chemical Analysis

In the present example, typical alumina chemical analyses are shown in Table I.

TABLE I
TYPICAL CHEMICAL ANALYSIS

| Constituents | Weight % |
|---|---|
| Soda as Na₂O | 0.4 |
| Iron as Fe₂O3 | 0.015 |
| Silicon as Si | 0.02 |
| Titanium as TiO₂ | 0.002 |
| Loss on Ignition | 5.5-6.0 |

### Example 2—Activated Alumina Typical Physical Properties

In the second example, typical alumina physical properties are shown in Table II.

TABLE II
TYPICAL PHYSICAL PROPERTIES

| | |
|---|---|
| Bulk Density (g/cm³) | 0.67 |
| Specific Surface Area (m²/g) | 350-380 |
| Pore Volume (cm³/g) | 0.44 |
| Static water adsorption (%) | 19-22 |

At 60% relative humidity and 20° C.

### Example 3—Uptake Capacity

In a third example, the removal uptake capacity of typical contaminants is shown below in Table III The capacity to remove phosphorus is expressed as mg of phosphate, PO₄, per gram of filtration media. The capacity to remove phosphorus reaches values of up to 40 mg/g. The filtration media also removes other contaminants such as arsenic, fluoride, lead, zinc and selenium.

TABLE III
UPTAKE CAPACITY

| | |
|---|---|
| Arsenic (As) | 10 mg/g |
| Fluoride (F) | 14 mg/g |
| Phosphate (PO₄) | 40 mg/g |
| Lead (Pb) | 5 mg/g |
| Zinc (Zn) | 15 mg/g |
| Selenium (Se) | 2.5 mg/g |

### Example 4—Dolomitic Lime

In a fourth example, the composition of typical dolomitic lime expressed as vol % is shown in Table IV.

TABLE IV
MINIMAL ANALYSIS GUARANTEE

| | |
|---|---|
| Calcium (Ca) | 29% |
| Magnesium (Mg) | 6% |
| Oxyde de calcium (CaO) | 41% |
| Oxyde de magnesium (MgO) | 10% |
| Calcium carbonate (CaCO₃) | 70% |
| Magnesium carbonate (MgCO₃) | 20% |

### Example 5—Phosphorus Removal Results

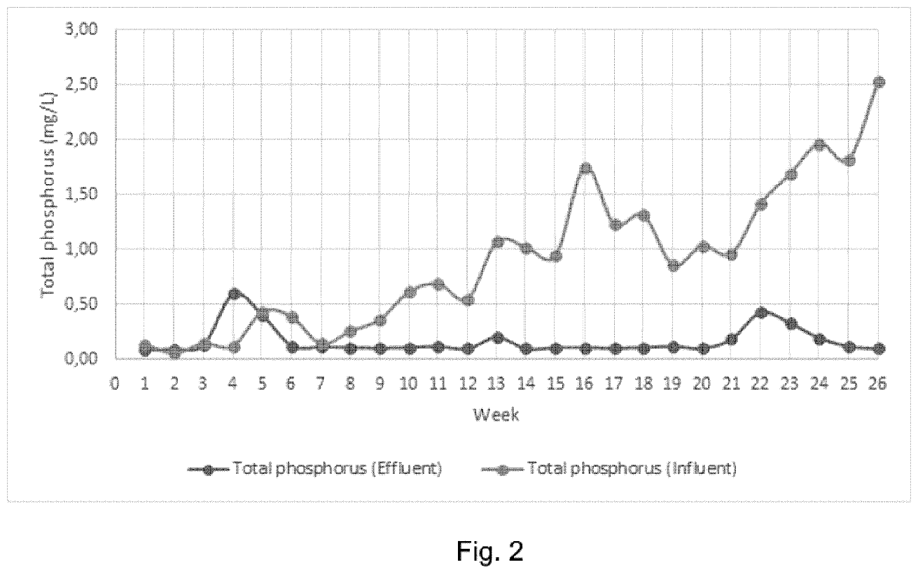

Now referring to FIG. 2, a plot of the exemplary results obtained using the system 100 is shown. The plot shows the concentration of phosphorus as a function of the number of weeks of the process at the inlet and outlet areas. FIG. 2 generally shows the performance of the filtration media in removing phosphorus from a wastewater feed stream. As the total phosphorus inlet concentration (expressed as mg of phosphate, PO₄, per volume of solution) increased in the feed stream up to 2.5 mg/L, the phosphorus outlet concentration remained fairly low even after 26 weeks of operation.

### Example 6—Fecal Coliform Removal Results

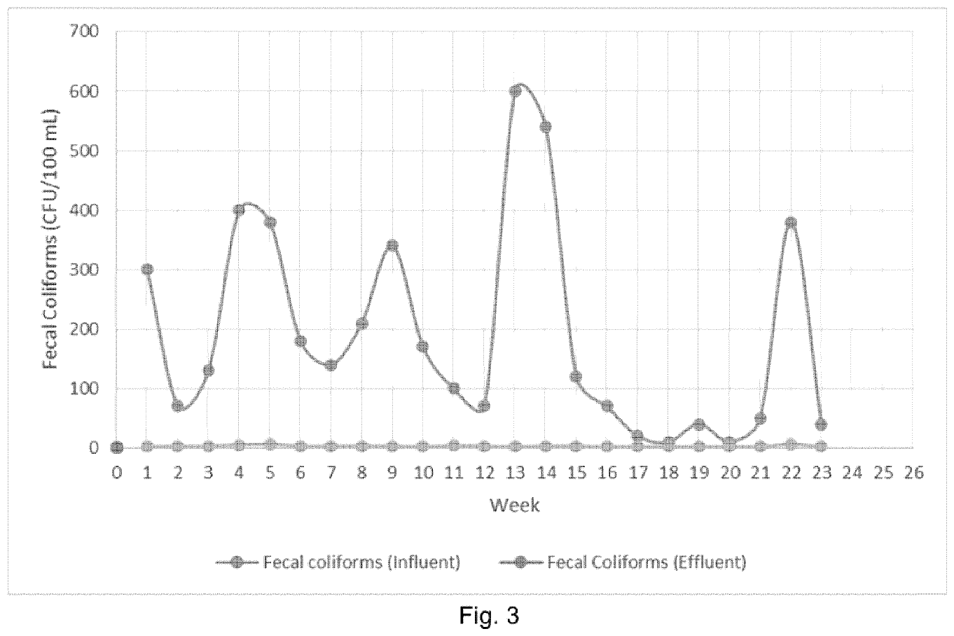

Now referring to FIG. 3, a plot of the exemplary results obtained using the system 100 is shown. The plot shows the concentration of fecal coliforms as a function of the number of weeks of the process at the inlet and outlet areas. FIG. 3 generally presents performance levels of the filtration media in removing fecal coliforms from a wastewater feed stream at different times during the process. As the concentration of fecal coliforms varied up to 700 CFU/100 mL, the exit concentration remained fairly low during 23 weeks of operation.

### Example 7—Filtration Media

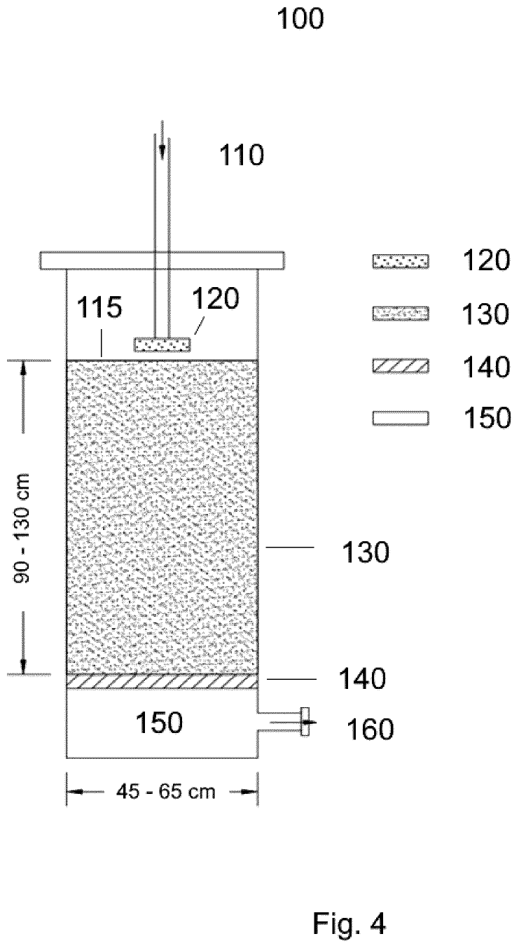

FIG. 4 shows a specific embodiment of the filtration media 130 inside de filtration system 100 in which the filtration media 130 has a diameter ranging from about 45 cm to about 65 cm and a height ranging from about 90 cm to about 130 cm. One of skill in the art will appreciate that the dimensions of the filtration media may be altered in infinite ways without departing from the nature and scope of the invention.

The methods apparatus and systems of the present invention may be used to treat wastewater streams as well as sewage wastewater streams originating from septic tanks by removing phosphorus and coliforms.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A filtration media to passively remove phosphorus and coliforms from wastewater or sewage streams comprising a material selected from the group consisting of sand filtering media, granular activated alumina, peat moss, dolomitic lime and any combination thereof.

2) The filtration media as defined in claim 1, the filtration media comprising:
sand filtering media;
granular activated alumina;
peat moss; and
dolomitic lime.

3) The filtration media as defined in claim 2, the filtration media comprising:
between 20-65 vol % of sand filtering media:
between 7-14 vol % of granular activated alumina;
between 25-50 vol % of peat moss; and
between 5-20 vol % of dolomitic lime.

4) The filtration media as defined in claim 3, wherein the sand filtering media comprises sand having:
an effective diameter (D10) of between about 0.15 and about 1 mm;
a uniformity coefficient (Cu) less than or equal to about 6;
3% or less of the particles have a diameter less than 80 μm; and
20% or less of the particles have a diameter greater than 2.5 mm.

5) The filtration media as defined in claim 2 wherein the dolomitic lime comprises a mixture of calcium carbonate and magnesium carbonate having a density of about 17.7±1.8 lb/m³.

6) The filtration media as defined in claim 2, wherein the granular activated alumina has a particle size of between about 0.6 mm and about 1.5 mm.

7) The filtration media as defined in claim 2, further comprising one or more other filtration material(s) suitable to remove phosphorus and coliforms from wastewater or sewage streams.

8) The filtration media as defined in claim 3, further comprising one or more other filtration material(s) suitable to remove phosphorus and coliforms from wastewater or sewage streams.

9) A filtration media system to passively remove phosphorus and coliforms from wastewater or sewage streams, the filtration media system comprising:
a housing or container;
an inlet;
a filtration media;
a filtration media support; and
an outlet.

10) The filtration media system as defined in claim 9, wherein the filtration media comprises:
sand filtering media;
granular activated alumina;
peat moss; and
dolomitic lime.

11) The filtration media system as defined in claim 9, wherein the filtration media comprises:
20-65 vol % of sand filtering media:
7-14 vol % of granular activated alumina;
25-50 vol % of peat moss; and
5-20 vol % of dolomitic lime.

12) The filtration media system of claim 9, the filtration media further comprising a diffusing mechanism near or at the end of the inlet.

13) The filtration media system as defined in claim 12, wherein the filtration media comprises:
sand filtering media;
granular activated alumina;
peat moss; and
dolomitic lime.

14) The filtration media system as defined in claim 12, wherein the filtration media comprises:
about 20-65 vol % of sand filtering media:
about 7-14 vol % of granular activated alumina;
about 25-50 vol % of peat moss; and
about 5-20 vol % of dolomitic lime.

15) A method to passively remove phosphorus and coliforms from wastewater or sewage streams comprising:
pumping and directing wastewater or sewage streams in the filtration media system as defined in claim 10;
allowing the wastewater to infiltrate the filtration media and accumulate at the bottom of the filtration media system; and
allowing the filtered water accumulated at the bottom of the filtration media system to exit via the outlet.

16) A method to passively remove phosphorus and coliforms from wastewater or sewage streams comprising:
pumping and directing wastewater or sewage streams in the filtration media system as defined in claim 11;
allowing the wastewater to infiltrate the filtration media and accumulate at the bottom of the filtration media system; and
allowing the filtered water accumulated at the bottom of the filtration media system to exit via the outlet.

17) A method to passively remove phosphorus and coliforms from wastewater or sewage streams comprising:
pumping and directing wastewater or sewage streams in the filtration media system as defined in claim 12;
allowing the wastewater to infiltrate the filtration media and accumulate at the bottom of the filtration media system; and
allowing the filtered water accumulated at the bottom of the filtration media system to exit via the outlet.

18) A method to passively remove phosphorus and coliforms from wastewater or sewage streams comprising:
pumping and directing wastewater or sewage streams in the filtration media system as defined in claim 13;
allowing the wastewater to infiltrate the filtration media and accumulate at the bottom of the filtration media system; and
allowing the filtered water accumulated at the bottom of the filtration media system to exit via the outlet.

19) A method to passively remove phosphorus and coliforms from wastewater or sewage streams comprising:
pumping and directing wastewater or sewage streams in the filtration media system as defined in claim 14;
allowing the wastewater to infiltrate the filtration media and accumulate at the bottom of the filtration media system; and
allowing the filtered water accumulated at the bottom of the filtration media system to exit via the outlet.
